(19) United States
(12) Patent Application Publication
(10) Pub. No.: US 2006/0002466 A1
(43) Pub. Date: Jan. 5, 2006

(54) Prediction encoder/decoder and prediction encoding/decoding method

(75) Inventor: Gwang-hoon Park, Seongnam-si (KR)

Correspondence Address: STAAS & HALSEY LLP, SUITE 700, 1201 NEW YORK AVENUE, N.W., WASHINGTON, DC, 20005, US

(73) Assignees: Samsung Electronics Co., LTD., Suwon-si (KR); Industry Academic Cooperation Foundation Kyunghee University, Youngin-Si (KR)

(21) Appl. No.: 11/141,263

(22) Filed: Jun. 1, 2005

(30) Foreign Application Priority Data
Jun. 1, 2004 (KR) 2004-0039807

(51) Int. Cl. H04B 1/66; H04N 11/02; H04N 11/04; H04N 7/12

(52) U.S. Cl. 375/240.03; 375/240.12; 375/240.24; 375/240.2; 375/240.23

(57) ABSTRACT

A prediction encoder/decoder and a prediction encoding/decoding method. The prediction encoder includes a prediction encoding unit starting prediction from a origin macroblock of an area of interest of a video frame, continuing prediction in a direction of ripple scanning with respect to a square ring that includes macroblocks and surrounds the origin macroblock, and encoding video by performing intra-prediction in 8×8 block units using information about a macroblock that has been just coded in a square ring including a macroblock to be coded and at least one of macroblocks that are adjacent to the macroblock to be coded in a square ring that has been just coded.

### CROSS-REFERENCE TO RELATED APPLICATION

This application claims the priority of Korean Patent Application No. 10-2004-0039807, filed on Jun. 1, 2004, in the Korean Intellectual Property Office, the disclosure of which is incorporated herein by reference.

### BACKGROUND OF THE INVENTION

1. Field of the Invention

The present invention relates to moving picture encoding, and more particularly, to a prediction encoder/decoder and a prediction encoding/decoding method for encoding of an area of interest.

2. Description of Related Art

New standards called MPEG-4 part 10 AVC (advanced video encoding) or ITU-T H.264 emerged in 2003 in the field of video compression. Fueling the emergence was a change from conventional circuit switching to packet switching and a need for coexistence of various communication infrastructures, along with the rapid spread of new communication channels such as mobile networks.

In AVC/H.264, spatial estimation encoding methods such as MPEG-1, MPEG-2, and MPEG-4 part 2 visual that differ from conventional international standards for moving picture coding are used. In conventional moving picture coding, coefficients transformed in a discrete cosine transform (referred to as a DCT transform hereafter) domain are subject to intra-prediction to improve encoding efficiency, resulting in degradation of subjective quality at low-pass band transmission bit rates. On the other hand, in AVC/H.264, spatial intra-prediction in a spatial domain, instead of in a DCT transform domain, is adopted.

From the point of view of an encoder, traditional spatial intra-prediction encoding is performed in such a way that information about a block to be encoded is predicted using information about a block that is already encoded and reproduced and difference information between information about an actual block to be encoded and the predicted block is only encoded and transmitted to a decoder side. At this time, a parameter required for prediction may be transmitted to the decoder side or prediction may be performed by synchronizing the encoder and the decoder. From the decoder's point of view, information about a block to be decoded is predicted using information about an adjacent block that is already decoded and reproduced, a sum of the predicted information and the difference information transmitted from the encoder side is calculated, and desired structure information is reproduced. At this time, if a parameter required for prediction is received from the encoder side, it is also decoded for use.

Intra-prediction of block-based or macroblock-based video encoding according to prior art entirely adopts prediction using information about blocks A, B, C, and D that are adjacent to a block E to be coded in a traditional raster scanning direction, as shown in FIG. 1. Information about blocks marked with X in FIG. 1 is to be processed after completion of encoding of the block E, and therefore, is not available in encoding processing. A block marked with O is available when a prediction value is calculated, but it is far from the block E on a spatial axis. As a result, the block marked with O does not have high correlation with the block E and is rarely used.

As such, most of conventional intra-prediction uses a part of information about the blocks D, B, and C that are adjacent to the block E to be coded among blocks in an upper line adjacent to a line including the block E and information about the block A that has been coded just before encoding of the block E. In the case of MPEG-4-part 2, a DC value of the block E is predicted using differences between DC values of the blocks A, D, and B in an 8×8 DCT transform domain. Also, in the case of AVC/H.264, a frame is divided into 4×4 blocks or 16×16 macroblocks and pixel values in a spatial domain, instead of in a DCT transform domain, are predicted.

FIG. 2 is a view for explaining intra-prediction encoding using 8×8 DCT coefficients according to the conventional art.

Referring to FIG. 2, 16×16 macroblocks are processed in 8×8 block units and a DC value is predicted for each block in a DCT transform domain.

In other words, in FIG. 2, four macroblocks D, B, A, and E are shown and each macroblock is divided into four blocks. In other words, the macroblock D is divided into blocks D1, D2, D3, and D4, the macroblock B is divided into blocks B1, B2, B3, and B4, the macroblock A is divided into blocks A1, A2, A3, and A4, and the macroblock E is divided into blocks E1, E2, E3, and E4. A black square at the top left corner of each 8×8 block indicates a DC value of the block.

Intra-prediction within a macroblock E to be coded is performed as follows.

(1) To perform intra-prediction in the macroblock E, it is checked whether the macroblocks A, B, and D exist. If some of the macroblocks A, B, and D exist outside a video object plane (VOP), a predicted DC value is determined to be 1024 (that is equal to 128 as a pixel value).

(2) To process the block E1, it is checked whether the blocks D4, B3, and A2 exist. If some of the blocks D4, B3, and A2 do not exist or are not intra-coded, a predicted value of the block E1 is determined to be 1024.

(3) If all of the blocks D4, B3, and A2 exist, an intra-predicted DC value of the block E1 is determined as follows. In other words, if a difference between a DC value of the block A2 and a DC value of the block D4 is smaller than a difference between a DC value of the block D4 and a DC value of the block B3, it means that there is a high probability that a DC value of the block E1 is similar to that of the block B3. Thus, the DC value of the block E1 is predicted from the DC value of the block B3. If the difference between the DC value of the block A2 and the DC value of the block D4 is larger than the difference between the DC value of the block D4 and the DC value of the block B3, the DC value of the block E1 is predicted from a DC value of the block A2. Such prediction can be applied to both the encoder side and the decoder side, and therefore, it is possible to perform intra-prediction encoding without transmitting a parameter for calculation of a predicted value. In other words, in the decoder side, a predicted value should be calculated in a manner similar to that of the encoder side.

Prediction of the block E1 can be arranged as follows.
If |A2_DC-D4_DC|<|D4_DC-B3_DC|, E1_DC=B3_DC Else, E1-DC=A2_DC

To predict a DC value of the block E2, (1) through (3) are performed using blocks E1, B3, and B4 that are adjacent to the block E2. To predict a DC value of the block E3, (1) through (3) are performed using blocks A2, A4, and E1 that are adjacent to the block E3. To predict a DC value of the block E4, (1) through (3) are performed using blocks E1, E2, and E3 that are adjacent to the block E4. In other words, intra-prediction based on 8×8 block units of the macroblock E is performed in a raster scanning direction in the form of Z.

AVC/H.264 video encoding is designed to have high network friendliness that will be important requirements for video encoding-related international standardization. To this end, AVC/H.264 employs slice-based independent encoding as one of its major functions. This is because that since data that undergoes compression encoding becomes very sensitive to a transmission error caused during transmission, there is a very high possibility that a part of corresponding bit streams is lost upon the occurrence of the transmission error and such a loss has a great influence on not only a portion having the loss but also restoration of an image that refers to the corresponding image, resulting in a failure to obtain flawless restoration. In particular, when using packet-based transmission that is widely used in an Internet or mobile communication network environment, if a packet error occurs during transmission, data following the damaged packet cannot be used for restoration of an image frame. Moreover, if a packet having header information is damaged, the entire data of the image frame cannot be restored, resulting in significant degradation of image quality. To solve such a problem, AVC/H.264 determines a slice that is smaller than a frame unit to be the smallest unit of data that can be independently decoded. More specifically, each slice is determined on the assumption that a slice can be perfectly decoded regardless of data corresponding to other slices that precede or follow the slice. Therefore, even when data of several slices is additionally damaged, there is a high possibility of restoration or concealment of an image of a damaged portion, using image data of slices that are decoded without an error, which can minimize degradation of image quality.

AVC/H.264 is designed to support not only a slice structure composed of groups of macroblocks in a raster scanning direction according to the conventional art, but also a new slice structure defined in flexible macroblock ordering (FMO). The new slice structure is adopted as an essential algorithm of a baseline profile and an extended profile. In particular, FMO mode 3 box-out scanning has modes, in each of which scanning is performed in the clockwise direction and in the counter-clockwise direction, as shown in FIG. 3.

Scanning, such as box-out scanning, employed in AVC/H.264 is very useful for encoding of a region of interest (ROI). According to such scanning, as shown in FIG. 3, scanning begins in the center of an ROI or the center of an image and then continues in such a way that each onion skin-like group of pixels, blocks, or macroblocks is sequentially layered in the shape of a square ring. In other words, scanning begins in a start region and continues in a way that a square ring is layered onto another square ring that is processed just before the previous square ring. When using ROI-centered scanning, conventional intra-prediction that is designed to fit for raster scanning cannot be used.

AVC/H.264 is methodology that carefully considers error resiliency and network friendliness to keep pace with the rapidly changing wireless environment and Internet environment. In particular, box-out scanning is methodology for ROI encoding. The box-out scanning makes it possible to improve compression efficiency based on human visual characteristics or to perform improved error protection and allows ROI processing with the highest priority.

However, since conventional video encoding such as AVC/H.264 employs intra-prediction encoding based on traditional raster scanning that is very different from ROI-centered scanning, it cannot be used when a technique for improving encoding efficiency is applied to video encoding that is based on ROI-centered scanning.

### BRIEF SUMMARY

An aspect of the present invention provides a prediction encoder/decoder and a prediction encoding/decoding method for encoding of an ROI.

According to one aspect of the present invention, there is provided a prediction encoder including a prediction encoding unit which starts prediction from an origin macroblock of an area of interest of a video frame, continues prediction in a direction of ripple scanning with respect to a square ring that includes macroblocks and surrounds the origin macroblock, and encodes video by performing intra-prediction in 8×8 block units using information about a macroblock that has been just coded in a present square ring including a macroblock to be coded and at least one of macroblocks that are adjacent to the macroblock to be coded in a previous square ring which is inner square ring adjacent to the present square ring.

The prediction encoding unit may predict a DCT coefficient of each block of the macroblock to be coded using a DCT coefficient of each block of the origin macroblock or a DCT coefficient of each block of the macroblock A, when the macroblock to be coded is a first macroblock after completion of encoding of the origin macroblock or there exist two reference macroblocks of the macroblock to be coded, wherein the two reference macroblocks includes a macroblock A that is included in the present square ring and has been just coded and a macroblock D that is included in the present square ring and is adjacent to the macroblock to be coded.

The prediction encoding unit may predict the remaining blocks after the prediction encoding unit first predicts, among the blocks of the macroblock to be coded, a block that is adjacent to the origin macroblock or the macroblock A,

The prediction encoding unit may predict a DCT coefficient of each block of the macroblock to be coded using DCT coefficients of blocks of the macroblocks A, B, and D, when a macroblock A that is included in the present square ring and has been just coded, a macroblock B that is included in the previous square ring and is adjacent to the macroblock to be coded, and a macroblock D that is included in the previous square ring and is adjacent to the macroblocks A and B exist as reference macroblocks of the macroblock to be coded,

The prediction encoding unit first may predict, among the blocks of the macroblock to be coded, a block E_{A} that is adjacent to the macroblocks A and B, a block E_{B} that is only adjacent to the macroblock A or a block E_{C} that is only adjacent to the macroblock B, and then a block E_{D} that is adjacent to the blocks E_{B} and E_{C}.

The prediction encoding unit may include a reference macroblock search unit searching for a reference macroblock included in the present square ring and a reference macroblock that is included in the previous square ring and is adjacent to the macroblock to be coded; a reference macroblock location determining unit determining the origin macroblock to be A if only the origin macroblock exists, determining a macroblock included in the present square ring to be A and a macroblock included in the previous square ring to be D if two macroblocks exist, each being included in the present square ring and in the previous square ring, and determining a macroblock that is included in the present square ring and has been just coded to be A, a macroblock that is adjacent to the macroblock to be coded in the previous square ring to be B, and a macroblock that is adjacent to the macroblocks A and B and is included in the previous square ring to be D, if a macroblock is included in the present square ring and at least two macroblocks are included in the previous square ring; and an intra-prediction unit encoding the macroblock in a predetermined scanning order of the blocks of the macroblock to be coded using the determined reference macroblocks A, B, and D.

The prediction encoding unit may include an intra-prediction mode determining unit determining a prediction mode having the minimum sum of absolute differences between the macroblock to be coded and each predicted macroblock in an intra-prediction mode according to a scanning order using the reference macroblocks A, B, and D that are determined to determine the scanning order.

The prediction encoding unit may include a discrete cosine transform (DCT) unit performing DCT on a difference between the intra-predicted macroblock and the macroblock to be coded; a quantization unit quantizing transformed DCT coefficients; a ripple scan unit starting scanning from the origin macroblock of a frame composed of the quantized DCT coefficients and continuing to scan macroblocks of a next square ring in a ripple scanning direction; and an entropy encoding unit entropy encoding ripple scanned data samples.

According to another aspect of the present invention, there is provided a prediction decoder including a prediction decoding unit which starts prediction from a origin macroblock of an area of interest of a video frame, continues prediction in a direction of ripple scanning with respect to a square ring that includes macroblocks and surrounds the origin macroblock, and decoding video by performing intra-prediction in 8×8 block units using information about a macroblock that has been just decoded in a present square ring including a macroblock to be decoded and at least one of macroblocks that are adjacent to the macroblock to be decoded in a previous square ring which is inner square ring adjacent to the present square ring.

The prediction encoding unit may predict a DCT coefficient of each block of the macroblock to be decoded using a DCT coefficient of each block of the origin macroblock or a DC coefficient of each block of the macroblock A, when the macroblock to be decoded is a first macroblock after completion of decoding of the origin macroblock or there exist two reference macroblocks of the macroblock to be decoded, wherein the two reference macroblocks include a macroblock A that is included in the present square ring having the macroblock to be decoded and has been just decoded and a macroblock D that is included in the previous square ring and is adjacent to the macroblock to be decoded.

The prediction encoding unit may predict the remaining blocks after the prediction decoding unit first predicts, among the blocks of the macroblock to be decoded, a block that is adjacent to the origin macroblock or the macroblock A.

The prediction encoding unit may predict a DCT coefficient of each block of the macroblock to be decoded using DCT coefficients of blocks of the macroblocks A, B, and D when a macroblock A that is included in the present square ring and has been just decoded, a macroblock B that is included in the previous square ring and is adjacent to the macroblock to be decoded, and a macroblock D that is included in the previous square ring and is adjacent to the macroblocks A and B exist as reference macroblocks of the macroblock to be decoded.

The prediction decoding unit first may predict, among the blocks of the macroblock to be decoded, a block E_{A} that is adjacent to the macroblocks A and B, a block E_{B} that is only adjacent to the macroblock A or a block E_{C} that is only adjacent to the macroblock B, and then a block E_{D} that is adjacent to the blocks E_{B} and E_{C}.

The prediction decoding unit may include a reference macroblock search unit searching for a reference macroblock included in the present square ring and a reference macroblock that is included in the previous square ring and is adjacent to the macroblock to be decoded; a reference macroblock location determining unit determining the origin macroblock to be A if only the origin macroblock exists, determining a macroblock included in the present square ring to be A and a macroblock included in the previous square ring to be D if two macroblocks exist, each being included in the present square ring and in the previous square ring, and determining a macroblock that is included in the present square ring and has been just decoded to be A, a macroblock that is adjacent to the macroblock to be decoded in the previous square ring to be B, and a macroblock that is adjacent to the macroblocks A and B and is included in the previous square ring to be D, if a macroblock is included in the present square ring and at least two macroblocks are included in the previous square ring; and an intra-prediction unit decoding the macroblock in a predetermined scanning order of the blocks of the macroblock to be decoded using the determined reference macroblocks A, B, and D.

The prediction decoding unit may include an intra-prediction mode determining unit determining a prediction mode having the minimum sum of absolute differences between the macroblock to be decoded and each predicted macroblock in an intra-prediction mode according to a scanning order using the reference macroblocks A, B, and D that are determined to determine the scanning order.

The prediction decoder may include an entropy decoding unit entropy decoding a bitstream received from a prediction encoder; a ripple scan unit starting scanning from the origin macroblock of a frame composed of entropy-decoded data samples and continuing to scan macroblocks of a next square ring in a ripple scanning direction; an inverse quantization unit inversely quantizing the ripple-scanned data samples; an inverse discrete cosine transform (IDCT) unit performing IDCT on the inversely quantized data samples; and an adder adding a macroblock composed of inversely-quantized and IDCTed coefficients to the predicted macroblock.

According to yet another aspect of the present invention, there is provided a prediction encoding method including prediction encoding by starting prediction from a origin macroblock of an area of interest of a video frame, continuing prediction in a direction of ripple scanning with respect to a square ring that includes macroblocks and surrounds the origin macroblock, and encoding video by performing intra-prediction in 8×8 block units using information about a macroblock that has been just coded in a present square ring including a macroblock to be coded and at least one of macroblocks that are adjacent to the macroblock to be coded in a previous square ring which is inner square ring adjacent to the present square ring.

According to still another aspect of the present invention, there is provided a prediction decoding method including prediction decoding by starting prediction from a origin macroblock of an area of interest of a video frame, continuing prediction in a direction of ripple scanning with respect to a square ring that includes macroblocks and surrounds the origin macroblock, and decoding video by performing intra-prediction in 8×8 block units using information about a macroblock that has been just decoded in a present square ring including a macroblock to be decoded and at least one of macroblocks that are adjacent to the macroblock to be decoded in a previous square ring which is inner square ring adjacent to the present square ring.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 shows reference blocks required for intra-prediction encoding in the raster scanning direction according to the conventional art;

FIG. 2 is a view for explaining intra-prediction encoding using 8×8 DCT coefficients according to the conventional art;

FIGS. 3A and 3B are views for explaining FMO mode 3 box-out scanning according to the conventional art;

FIG. 4 is a view for explaining locations of macroblocks in a current square ring to perform intra-prediction encoding according to an order that scanning begins in the center of a square and continues in the shape of a square ring;

FIGS. 5A (parts (a1) and (a2)) and 5B (parts (b1) and (b2)) show a scanning order of prediction coding on a block-by-block basis when a first block only exists after an origin block or a macroblock is coded according to an embodiment of the present invention;

FIGS. 6A through 6D (respective parts (a1) through (d2)) show a scanning order of intra-prediction coding on a block-by-block basis when two reference macroblocks only exist, in which the two reference macroblocks include a macroblock D of a square ring that is immediately inwardly adjacent to a square ring having a macroblock to be coded and a macroblock (A) that is included in the same square ring having the macroblock to be coded, has been just coded, and can be referred to, according to an embodiment of the present invention;

FIGS. 7A through 7H (respective parts of (a1) through (h2)) show intra-prediction on a block-by-block basis when at least three reference macroblocks exist, in which the at least three reference macroblocks include a macroblock that is included in the same square ring having a macroblock to be coded, has been just coded, and can be referred to and at least two macroblocks that are included in a square ring that is immediately inwardly adjacent to the square ring having the macroblock to be coded, according to an embodiment of the present invention;

FIG. 8 is a schematic block diagram of an intra-prediction encoder according to an embodiment of the present invention;

FIG. 9 is a schematic block diagram of an intra-prediction decoder according to an embodiment of the present invention;

FIG. 10 is a detailed block diagram of the intra-prediction mode selection unit shown in FIG. 8;

FIG. 11 is a flowchart illustrating an intra-prediction encoding method according an embodiment of to the present invention;

FIG. 12 is a detailed flowchart illustrating the intra-prediction procedure shown in FIG. 11;

FIG. 13 is a flowchart illustrating an intra-prediction decoding method according to an embodiment of the present invention; and

FIG. 14 is a detailed flowchart illustrating the intra-prediction procedure shown in FIG. 13.

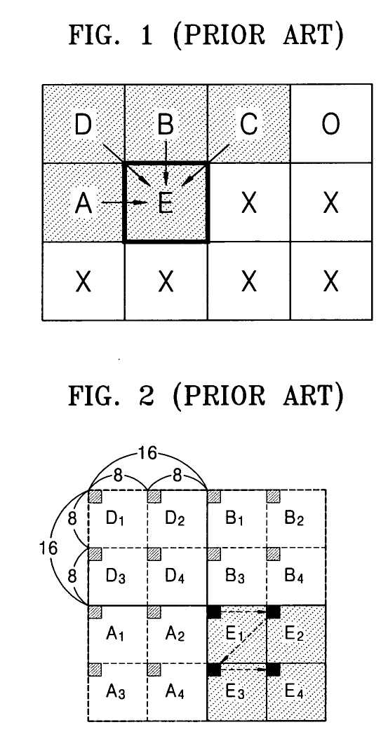

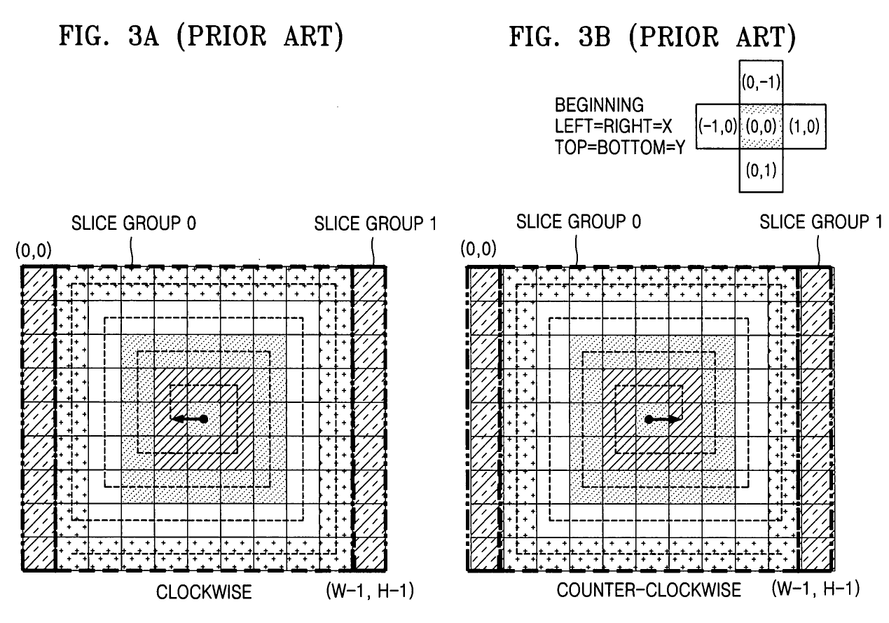

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

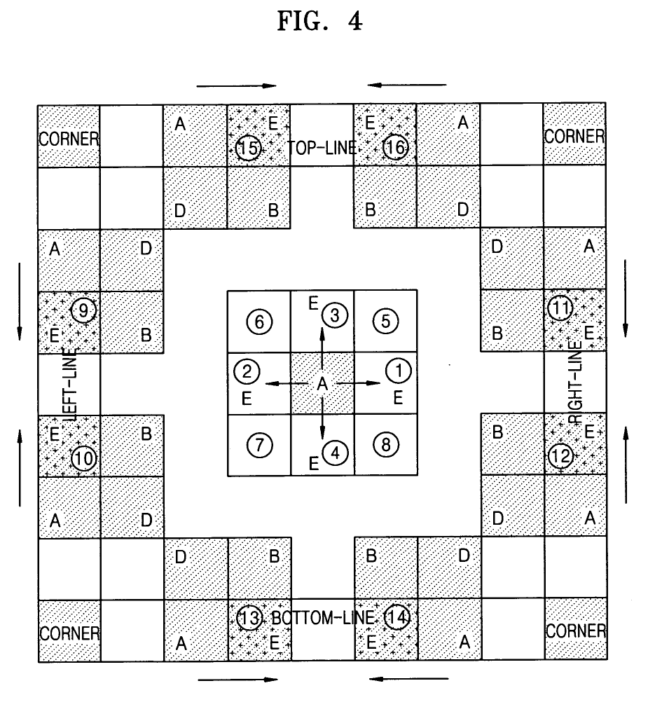

FIG. 4 is a view for explaining locations of macroblocks in a current square ring to perform intra-prediction encoding according to an order that scanning begins in the center of a square and continues in the shape of a square ring.

In an image frame shown in FIG. 4, a macroblock marked with A at the center is an origin macroblock or a center macroblock and macroblocks 1, 2, 3, 4, 5, 6, 7, and 8 that surround the origin macroblock form a square ring. In an ROI scanning method according to an embodiment of the present invention, the origin macroblock is first coded and macroblocks that surround the origin macroblock and form the square ring are then coded. As such, in the ROI scanning method, macroblocks are coded as if an onion skin is peeled from the center of the onion or a ripple is created. Intra-prediction encoding differs according to the location of each macroblock and an order of scanning. The same thing is applied to decoding.

In other words, to adaptively perform intra-prediction encoding in block or macroblock units in an order that scanning begins in the center of a square composed of a macroblock and continues in the shape of a square ring, as shown in FIG. 4, the locations of reference blocks or reference macroblocks required for prediction differ depending on four lines of the square ring, i.e., a top line, a bottom line, a left line, and a right line, and intra-prediction encoding is divided into two methods according to the direction of scanning.

According to the characteristic of ROI-centered scanning in which square rings are layered from the inside to the outside, there is no possibility that a reference macroblock is located outside a slice, a VOP, or a frame to be coded. Therefore, there can be the following cases: (a) there exists only one macroblock that can be referred to; (b) there exist only two macroblocks that can be referred to, in which the two macroblocks include a macroblock of a line of an adjacent square ring that is on the inside of diagonal directions from a macroblock that is being coded towards the origin macroblock and a macroblock that has been just coded and can be referred to within the same square ring having the macroblock that is being coded; and (c)there exist at least three macroblocks that can be referred to, in which the three macroblocks include a macroblock that has been just coded in a scanning direction and can be referred to within the present square ring having a macroblock that is being coded and at least two macroblocks of a previous square ring that is immediately inwardly adjacent to the present square ring having the macroblock that is being coded towards the origin macroblock.

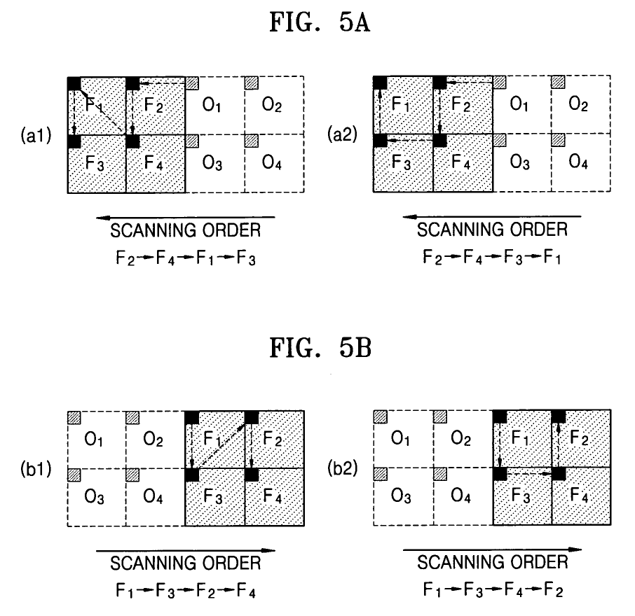

In the case of (a), in ROI-centered scanning, after encoding or decoding of the origin macroblock located at the initial origin (usually, located in the center of an image frame) is completed, a first block or macroblock is coded or decoded. Macroblocks marked with 1, 2, 3, and 4 are coded or decoded in this way. Intra-prediction of this case will be explained with reference to FIGS. 5A and 5B.

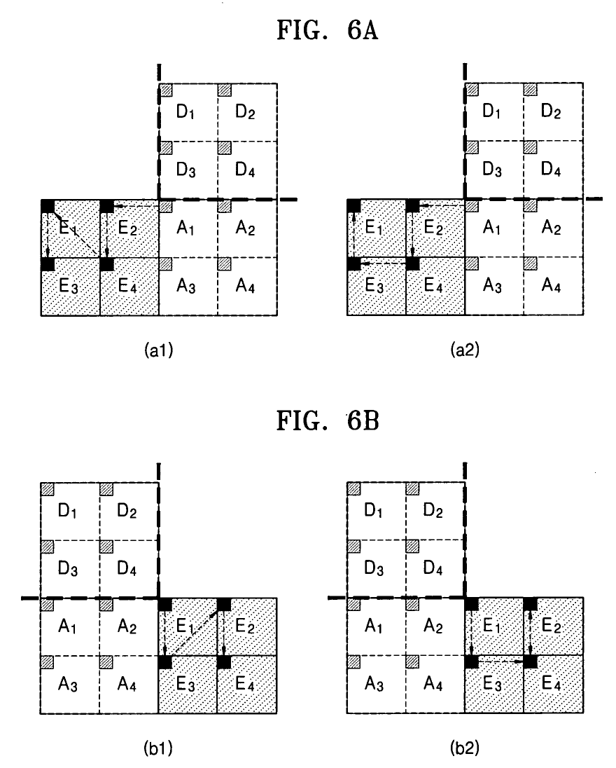

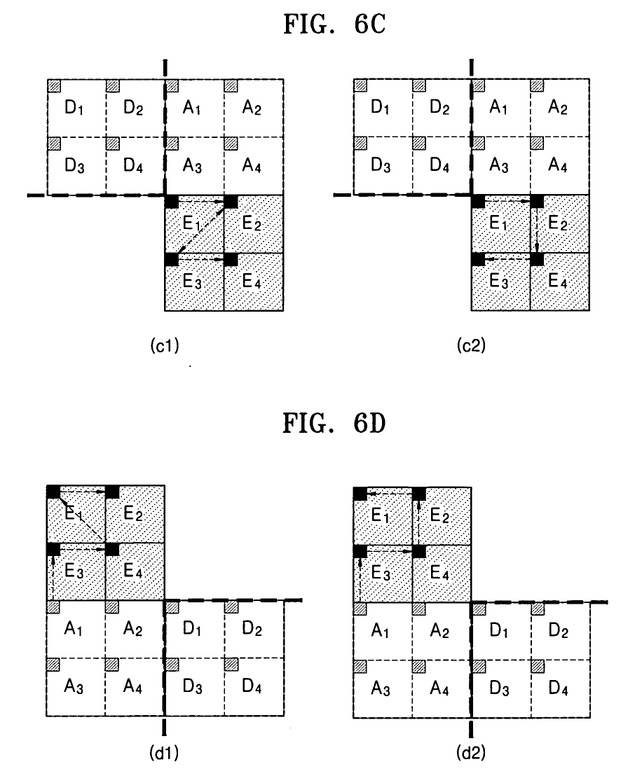

In the case of (b), i.e., when there exist a total of two macroblocks that can be referred to, in which the two macroblocks include a macroblock of a line of an adjacent square ring that is on the inside of diagonal directions from a macroblock that is being coded towards the origin macroblock and a macroblock that has been just coded and can be referred to within the present square ring having the macroblock that is being coded, from the standpoint of the macroblock that is being coded, the macroblock that has been just coded and is included in a previous square ring that is inwardly adjacent to the square ring having the macroblock that is being coded is located in a diagonal direction with respect to a current macroblock at all times due to the scanning direction. As a result, corresponding information is not reliable. Thus, information of the macroblock that is located within the present square ring having the macroblock that is being coded and has been just coded in the scanning direction is only reliable and can be used for intra-prediction. Macroblocks marked with 5, 6, 7, and 8 are coded or decoded in this way. Intra-prediction of this case will be explained with reference to FIGS. 6A through 6D.

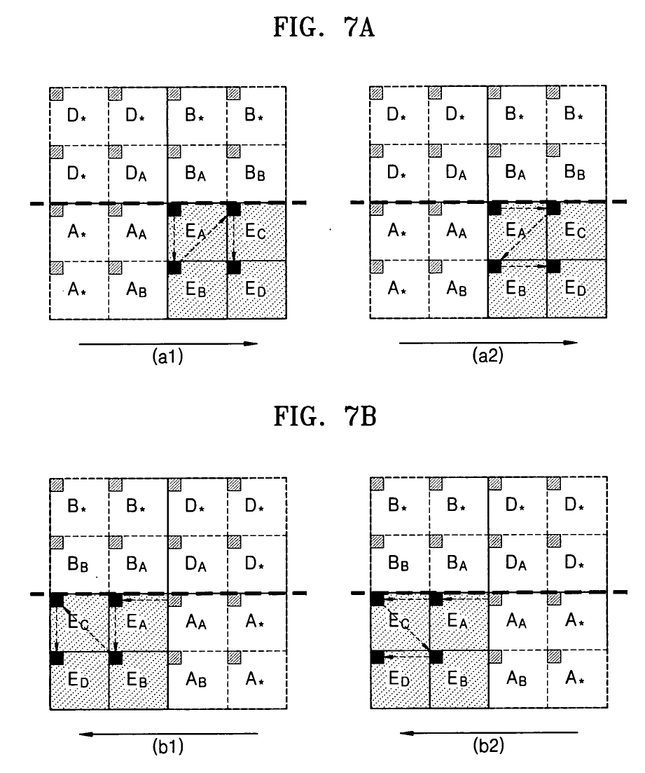

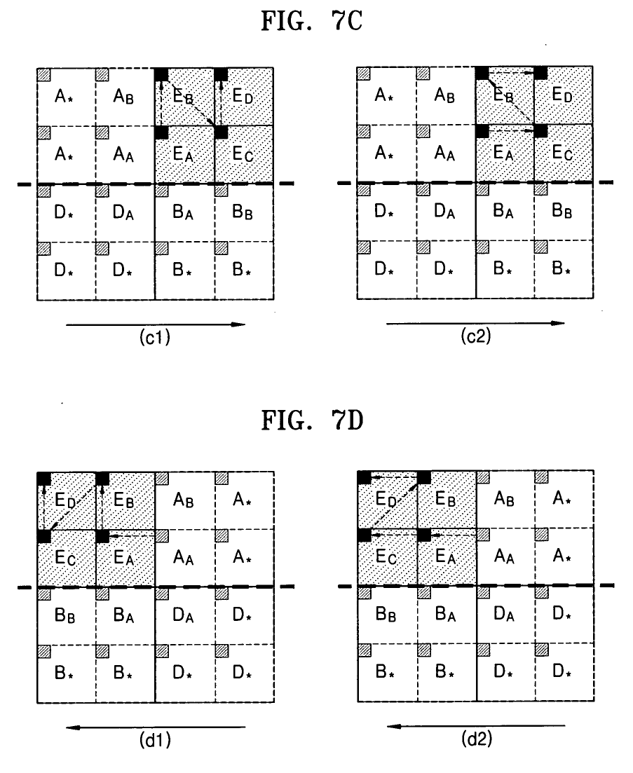

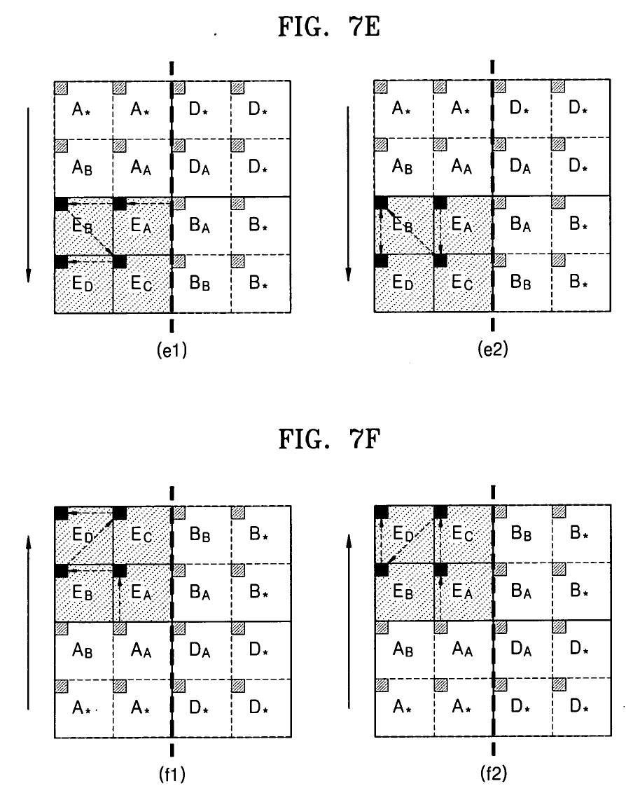

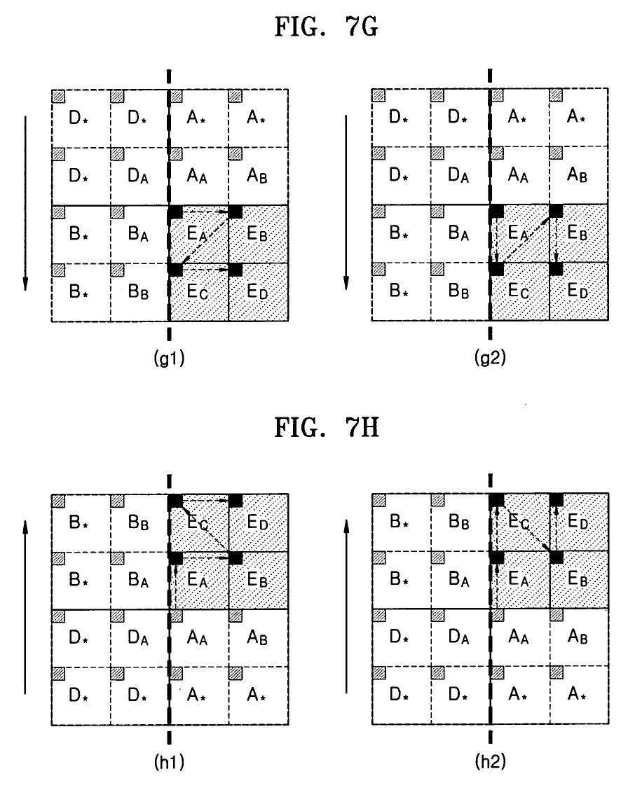

In the case of(c), there is one macroblock that is included in the present square ring having the macroblock to be coded, has been just coded in the scanning direction, and can be referred to, there are at least two macroblocks that can be referred to and are included in a previous square ring that is inwardly adjacent to the present square ring having the macroblock to be coded towards the origin macroblock, and macroblocks marked with 9, 10, 11, 12, 13, 14, and 15 in FIG. 4 correspond to such macroblocks that can be referred to. Referring to FIG. 4, in the case of (c), there is a macroblock A that is adjacent to a macroblock E in the present square ring having the macroblock E, there is a macroblock B that is adjacent to the macroblock E in a previous square ring that has been just coded, and there is a macroblock D that is adjacent to the macroblock A and the macroblock B. Intra-prediction in (c) will be described with reference to FIGS. 7A through 7H.

FIGS. 5A and 5B show a scanning order in intra-prediction of a first block or macroblock after the origin block or macroblock is coded according to an embodiment of the present invention. In this case, in a macroblock F to be coded, it is preferable that two blocks adjacent to an origin macroblock are first predicted and the remaining two blocks are then predicted.

Parts (a1) and (a2) of FIG. 5A show two scanning orders when a macroblock to be coded is located on the left side of the origin macroblock. Parts (b1) and (b2) of FIG. 5B show two scanning orders when the macroblock to be coded is located on the right side of the origin macroblock.

First, referring to part (a1) of FIG. 5A, a scanning order is F2→F4→F1→F3.

In other words, in intra-prediction of a block F2 of the macroblock F, a DC value of the block F2 is predicted using a DC value of a block O1 of an (origin) macroblock O:

In intra-prediction of a block F4 of the macroblock F, a DC value of the block F4 is predicted using DC values of the blocks O1, O3, and F2 as follows.
If |O1_DC-O3_DC|<|O1_DC-F2_DC|, F4_DC=F2_DC Else, F4_DC=O3_DC

In intra-prediction of the block F1, a DC value of the block F1 is predicted using a DC value of the block F2.

Also, in intra-prediction of the block F3, a DC value of the block F3 is intra-predicted using DC values of the blocks F1, F3, and F4 as follows.
If |F2_DC-F1_DC|<|F2_DC-F4_DC|, F3_DC=F4_DC Else, F3_DC=F1_DC

Referring to part (a2) of 5A, the scanning order is F2→F4→F3→F1.

In intra-prediction of the block F2 of the macroblock F, a DC value of the block F2 is predicted using the DC value of the block O1 of the (origin) macroblock O.

In intra-prediction of the block F4, a DC value of the block F4 is predicted using the DC values of the blocks O1, O3, and F2 as follows.
If |O1_DC-O3_DC|<|O1_DC-F2_DC|, F4_DC=F2_DC Else, F4_DC=O3_DC

In intra-prediction of the block F3, the DC value of the block F3 is predicted using the DC value of the block F4.

Also, the DC value of the block F1 is predicted using the DC values of the blocks F2, F4, and F3 as follows.
If |F4_DC-F2_DC|<|F4_DC-F3_DC| FL_DC=F3_DC Else, F1_DC=F2_DC

Besides, a scanning order, i.e., F2→F1→F4→F3, can be used, but it cannot sufficiently use information of a reference block in comparison to when the blocks F2 and F4 that are closest to the origin macroblock are preferentially predicted.

Next, a scanning order when a macroblock to be coded is located on the right side of the origin macroblock will be described.

First, referring to part (b1) of FIG. 5B, the scanning order is F1→F3→F2→F4.

Intra-prediction of the block F1 of the macroblock F, a DC value of the block F1 is predicted using the DC value of the block O2 of the (origin) macroblock.

In intra-prediction of the block F3, a DC value of the block F3 is predicted using the DC values of the blocks O2, O4, and F1 as follows.
If |O2_DC-O4_DC|<|O2_DC-F1_DC|, F3-DC=F1-DC
Else, F3_DC=O4_DC

In intra-prediction of the block F2, a DC value of the block F2 is predicted using the DC value of the block F1.

In intra-prediction of the block F4, a DC value of the block F4 is predicted using the DC values of the blocks F1, F2, and F3 as follows.
If |F1_DC-F3_DC|<|F1_DC-F2_DC|, F4_DC=F2_DC
Else, F4_DC=F3_DC

Referring to part (b2) of FIG. 5B, the scanning order is F1→F3→F4→F2.

In intra-prediction of the block F1 of the macroblock F, a DC value of the block F1 is predicted using the DC value of the block O2 of the (origin) macroblock.

In intra-prediction of the block F3, a DC value of the block F3 is predicted using the DC values of the blocks O2, O4, and F1 as follows.
If |O2_DC-O4_DC|<|O2_DC-F1_DC|, F3_DC=F1_DC Else, F3_DC=O4_DC

In intra-prediction of the block F4, a DC value of the block F4 is predicted using the DC value of the block F3.

In intra-prediction of the block F2, a DC value of the block F2 is predicted using the DC values of the blocks F1, F3, and F4 as follows.
If |F3_DC-F1_DC|<|F3_DC-F4_DC|, F2_DC=F4_DC Else, F2_DC=F1_DC

Besides, a scanning order, i.e., F1→F2→F3→F4, can be used, but it cannot sufficiently use information of a reference block in comparison to when the blocks F1 and F3 that are closest to the origin macroblock are preferentially predicted.

As such, in the case of (a), two scanning orders except for the third scanning order that is less efficient can be applied. In other words, one is an N-shape scanning order that two blocks adjacent to the origin macroblock are first predicted, one of the remaining two blocks is predicted, and the last block is predicted. The other is a c-shape scanning order that two blocks adjacent to the origin macroblock are first predicted, one of the remaining two blocks that is opposite direction to the first predicted macroblock, and the last macroblock is predicted. In terms of a system, one of the two scanning orders may be predetermined and prediction may be performed in the predetermined scanning order. Further, after prediction is performed using both the two scanning orders, one of them that brings better results is selected, and then prediction is performed using the selected scanning order. This makes the system more complicated. However, it is more efficient.

FIGS. 6A through 6D show a scanning order of intra-prediction coding on a block-by-block basis when two reference macroblocks only exist, in which the two reference macroblocks include a macroblock D of a previous square ring that is immediately inwardly adjacent to a previous square ring having a macroblock to be coded and a macroblock (A) that is included in the present square ring having the macroblock to be coded, has been just coded, and can be referred to, according to an embodiment of the present invention.

As such, when two macroblocks exist adjacently to a macroblock to be coded, there may be four cases as shown in FIGS. 6A through 6D.

As shown in FIG. 6A, from the point of view of the macroblock to be coded, a macroblock (D) of a previous square ring that has been just coded and is inwardly adjacent to the present square ring having the macroblock to be coded is located diagonally to the macroblock to be coded. As a result, information within the macroblock (D) cannot be reliably used at all times. Thus, information of the macroblock A that has been just coded in the present square ring having the macroblock to be coded is only reliable and intra-prediction can be performed in block units in the macroblock E.

Cases shown in FIGS. 6A and 6B can be processed in the same manner as in FIGS. 5A and 5B. In other words, when the (origin) macroblock O of FIGS. 5A and 5B is regarded as the macroblock A of FIGS. 6A and 6B and the macroblock F of FIGS. 5A and 5B is regarded as the macroblock E of FIGS. 6A and 6B, the cases shown in FIGS. 6A and 6B can be processed in the same manner as in FIGS. 5A and 5B.

In the case of FIG. 6C, a total of three methods can be used for intra-prediction in block units in the macroblock E.

Referring to part (c1) of FIG. 6C, the scanning order is E1→E2→E3→E4.

In intra-prediction of the block E1 of the macroblock E, a DC value of the block E1 is predicted using a DC value of a block A3 of a reference macroblock A.

In intra-prediction of the block E2, a DC value of the block E2 is predicted using DC values of blocks A3, A4, and E1 as follows.
If |A3_DC-A4_DC|<|A3_DC-E1_DC|, E2_DC=E1_DC Else, E2_DC=A4_DC

In intra-prediction of a block E3, a DC value of the block E3 is predicted using a DC value of the block E1.

In intra-prediction of a block E4, a DC value of the block E4 is predicted using DC values of blocks E1, E2, and E3 as follows.
If |E1_DC-E3_DC|<|E1_DC-E2_DC|, E4_DC=E2_DC Else, E4_DC=E3_DC

Referring to part (c2) of FIG. 6C, the scanning order is E1→E2→E4→E3.

In intra-prediction of the block E1 of the macroblock E, a DC value of the block E1 is predicted using a DC value of the block A3 of the reference macroblock A.

In intra-prediction of the block E2, a DC value of the block E2 is predicted using DC values of the blocks A3, A4, and E1 as follows.
If |A3_DC-A4_DC|<|A3_DC-E1_DC|, E2_DC=E1_DC Else, E2_DC=A4_DC

In intra-prediction of the block E4, a DC value of the E4 is predicted using a DC value of the block E2.

In intra-prediction of the block E3, a DC value of the block E3 is predicted using DC values of the blocks E1, E2, and E4 as follows.
If |E2_DC-E1_DC|<|E2_DC-E4_DC|, E3_DC=E4_DC Else, E3_DC=E1_DC

Besides, a scanning order, i.e., E1→E3→E2→E4, can be used, but it cannot sufficiently use information of a reference macroblock in comparison to when the blocks E1 and E2 that are closest to the reference macroblock are preferentially predicted.

In the case of FIG. 6D, a total of three methods can be used for intra-prediction in block units in the macroblock E.

Referring to part (d1) of FIG. 6D, the scanning order is E3→E4→E1→E2.

In intra-prediction of the block E3 of the macroblock E, a DC value of the block E3 is predicted using a DC value of the block Al of the reference macroblock A.

In intra-prediction of the block E4, a DC value of the block E4 is predicted using DC values of the blocks A1, A2, and E3 as follows.
If |A1_DC-A2_DC|<|A1_DC-E3_DC|, E4_DC=E3_DC Else, E4_DC=A2_DC

In intra-prediction of the block E1, a DC value of the block E1 is predicted using a DC value of the block E3.

In intra-prediction of the block E2, a DC value of the block E2 is predicted using DC values of the blocks E1, E3, and E4 as follows.
If |E3_DC-E1_DC|<|E3_DC-E4_DC|, E2_DC=E4_DC Else, E2_DC=E1_DC

Referring to part (d2) of FIG. 6D, the scanning order is E3→E4→E2→E1.

In intra-prediction of the block E3 of the macroblock E, a DC value of the block E3 is predicted using a DC value of the block A1 of the reference macroblock A.

In intra-prediction of the block E4, a DC value of the block E4 is predicted using DC values of the blocks A1, A2, and E3 as follows.
If |A1_DC-A2_DC|<|A1_DC-E3_DC|, E4_DC=E3_DC Else, E4_DC=A2_DC

In intra-prediction of the block E2, a DC value of the block E2 is predicted using a DC value of the block E4.

In intra-prediction of the block E1, a DC value of the block E1 is predicted using DC values of the blocks E2, E3, and E4 as follows.
If |E4_DC-E3_DC|<|E4_DC-E2_DC|, E1_DC=E2_DC Else, E1_DC=E3_DC

Besides, a scanning order, i.e., E3→E1→E4→E2, can be used, but it cannot sufficiently use information of a reference macroblock in comparison to when the blocks E3 and E4 that are closest to the reference macroblock are preferentially predicted.

As such, in the case of (b), two scanning orders except for the third scanning order that is less efficient can be applied. In other words, one is an N-shape scanning order that two blocks adjacent to the macroblock A are first predicted, one of the remaining two blocks is predicted, and the last block is predicted. The other is a [symbol] -shape scanning order that two blocks adjacent to the macroblock A are first predicted, one of the remaining two blocks that is opposite direction to the first predicted macroblock, and the last macroblock is predicted. In terms of a system, one of the two scanning orders may be predetermined and prediction may be performed in the predetermined scanning order. Further, after prediction is performed using both the two scanning orders, one of them that brings better results is selected, and then prediction is performed using the selected scanning order. This makes the system more complicated. However, it is more efficient.

As shown in FIGS. 5A through 6D, in ROI scanning, intra-prediction coding in block units can be performed using the same method and device for a case where a first macroblock is coded or decoded after coding or decoding of the initial origin, i.e., a macroblock located at the center of an image frame and a case where two reference macroblocks exist, in which the reference macroblocks include a macroblock in a previous square ring that is inwardly adjacent to a present square ring having a macroblock to be coded and a macroblock that has been just coded in the same square ring having the macroblock to be coded and can be referred to.

FIGS. 7A through 7H show intra-prediction on a block-by-block basis when at least three reference macroblocks exist, in which the at least three reference macroblocks include a macroblock that is included in the present square ring having a macroblock to be coded, has been just coded, and can be referred to and at least two macroblocks that are included in a previous square ring that is immediately inwardly adjacent to the present square ring having the macroblock to be coded, according to an embodiment of the present invention.

A case where one macroblock that has been just coded in the present square ring and can be referred to exists and at least two macroblocks can referred to in a previous square ring that is immediately inwardly adjacent to the present square ring having the macroblock to be coded for intra-prediction of the macroblock to be coded in block units is processed using the following method and device. First, a macroblock E to be intra-predicted and adjacent reference macroblocks are defined as follows.

A macroblock that exists in the present square ring having the macroblock E and has been just coded prior to the macroblock E is defined as a macroblock A.

A macroblock that is adjacent to the macroblock E and exists in a previous square ring that has been just coded is defined as a macroblock B.

A macroblock that is adjacent to the macroblocks A and B and exists in a previous square ring that has been just coded is defined as a macroblock D.

By using the above-defined reference macroblocks A, B, and D, intra-prediction of the macroblock E is performed in block units as follows.

(1) Intra-Prediction of E_{A}

In the macroblock E, when a block that is simultaneously adjacent to the macroblocks A, B, and D is defined as a block E_{A}, a block that is adjacent to the block E_{A} and is included in the macroblock A is defined as a block A_{A}, a block that is adjacent to the block E_{A} and is included in the macroblock B, and a block that is adjacent to the block E_{A} and is included in the macroblock D is defined as a block D_{A}, intra-prediction of E_{A} is performed as follows.
If |D_{A}_{_{—}}DC-A_{A}_{_{—}}DC|<|D_{A}_{_{—}}DC-B_{A}_{_{—}}DC|, E_{A}_{_{—}}DC=B_{A}_{_{—}}DC Else, E_{A}_{_{—}}DC=A_{A}_{_{—}}DC

(2) Intra-Prediction of E_{B}

When a block that is simultaneously adjacent to the block E_{A} and the macroblock A is defined as a block E_{B}, and a macroblock that is adjacent to the block E_{B} and is included in the macroblock A is defined as a block A_{B}, intra-prediction of the block E_{B} is performed using the blocks A_{A}, E_{A}, and A_{B} defined in (1) as follows.
If |A_{A}_{_{—}}DC-A_{B}_{_{—}}DC|<|A_{A}_{_{—}}DC-E_{A}_{_{—}}DC|, E_{B}_{_{—}}DC=E_{A}_{_{—}}DC Else, E_{B}_{_{—}}DC=A_{B}_{_{—}}DC

(3) Intra-Prediction of E_{C}

When a block that is simultaneously adjacent to the block E_{A} and the macroblock B is defined as a block E_{C} and a block that is adjacent to the block E_{C} and is included in the macroblock B is defined as a block B_{B}, intra-prediction of the block E_{C} is performed using the blocks B_{A}, E_{A}, and B_{B} as follows.
If |B_{A}_{_{—}}DC-B_{B}_{_{—}}DC|<|B_{A}_{_{—}}DC-E_{A}_{_{—}}DC|, E_{C}_{_{—}}DC=E_{A}_{_{—}}DC Else, E_{C}_{_{—}}DC=B_{B}_{_{—}}DC

(4) Intra-Prediction of E_{D}

When a block that is simultaneously adjacent to the blocks E_{A}, E_{B}, and E_{C} in the macroblock E is defined as a block E_{D}, intra-prediction of the block E_{D} is performed using the blocks E_{A}, E_{B}, and E_{C} as follows.
If |E_{A}_{_{—}}DC-E_{B}_{_{—}}DC|<|E_{A}_{_{—}}DC-E_{C}_{_{—}}DC|, E_{D}_{_{—}}DC=E_{C}_{_{—}}DC Else, E_{D}_{_{—}}DC=E_{B}_{_{—}}DC

According to the four methods described above, intra-prediction can be performed in the encoder side and the decoder side in a scanning order of E_{A}→E_{B}→E_{C}→E_{D} or E_{A}→E_{C}→E_{B}→E_{D} using the same method.

In otherwords, when there exist reference macroblocks A, B, and D for prediction of the macroblock E to be coded, as a first prediction order, the block E_{A} that is adjacent to the macroblocks A and B is first predicted, the block E_{B} that is adjacent to the macroblock A is predicted, the block E_{C} that is adjacent to the macroblock C is predicted, and then the block E_{D} that is adjacent to the blocks E_{B} and E_{C} is predicted. As a second prediction order, the block E_{A} that is adjacent to the macroblocks A and B is first predicted, the block E_{C} that is adjacent to the macroblock B is predicted, the block E_{B} that is adjacent to the macroblock A is predicted, and the block E_{D} that is adjacent to the blocks E_{B} and E_{C} is predicted. In any of the first and second scanning orders, the block E_{A} that is simultaneously adjacent to the macroblocks A and B is first predicted and the block E_{D} that is simultaneously adjacent to the block E_{B} and E_{C} is last predicted. However, the two scanning orders are different according to which one of the block E_{C} and E_{B} is predicted earlier.

Parts (a1) and (a2) of FIG. 7A show two prediction orders when a macroblock to be coded is located in 13 in FIG. 4, parts (b1) and (b2) of FIG. 7B show two prediction orders when a macroblock to be coded is located in 14 in FIG. 4, parts (c1) and (c2) of FIG. 7C show two prediction orders when a macroblock to be coded is located in 15 in FIG. 4, parts (d1) and (d2) of FIG. 7D show two prediction orders when a macroblock to be coded is located in 16 in FIG. 4, parts (e1) and (e2) of FIG. 7E show two prediction orders when a macroblock to be coded is located in 9 in FIG. 4, parts (f1) and (f2) of FIG. 7F show two prediction orders when a macroblock to be coded is located in 10 in FIG. 4, parts (g1) and (g2) of FIG. 7G show two prediction orders when a macroblock to be coded is located in 11 in FIG. 4, and parts (h1) and (h2) of FIG. 7H show two prediction orders when a macroblock to be coded is located in 12 in FIG. 4.

In the case of (c), two scanning orders except for the third scanning order that is less efficient can be applied. In other words, one is an N-shape scanning order that blocks adjacent to the macroblock A are first predicted, blocks adjacent to the macroblock B are predicted, and the last block is predicted. The other is a scanning order that blocks adjacent to the macroblock B are first predicted, blocks that are adjacent to the macroblock A are predicted, and the last macroblock is predicted. In terms of a system, one of the two scanning orders may be predetermined and prediction may be performed in the predetermined scanning order. Further, after prediction is performed using both the two scanning orders, one of them that brings better results is selected, and then prediction is performed using the selected scanning order.

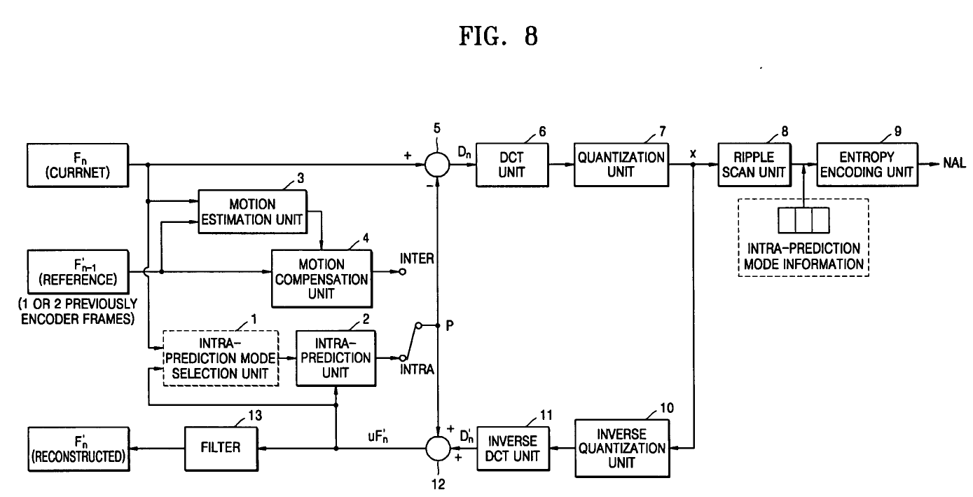

FIG. 8 is a schematic block diagram of an intra-prediction encoder according to an embodiment of the present invention.

Referring to FIG. 8, the intra-prediction encoder includes an intra-prediction mode selection unit 1, an intra-prediction unit 2, a motion estimation unit 3, a motion compensation unit 4, a subtraction unit 5, a DCT transform unit 6, a quantization unit 7, a ripple scan unit 8, an entropy encoding unit 9, an inverse quantization unit 10, an inverse DCT transform unit 11, an adder 12, and a filter 13.

The intra-prediction encoder includes two data flow paths. One is a forward path that runs from left to right and the other is a reconstructed path that runs from right to left.

First, the forward path will be described.

An input frame Fn is provided for prediction encoding. A frame is processed in macroblock units each corresponding to 16×16 pixels of the original image. Each macroblock is encoded in an intra or inter mode. In any of the intra mode and inter mode, a predicted macroblock P is created based on a reconstructed frame.

In the intra mode, the predicted macroblock P is created through motion compensated prediction after motion estimation by the motion estimation unit 3 based on at least one reference frame F′n-1 and motion compensation by the motion compensation unit 4. The reference frame is indicated by F′n-1 that is previously encoded. However, prediction of each macroblock can be performed using one or two past frames that is or are previously encoded and reconstructed.

In the intra mode, the predicted macroblock P is created from samples of a current frame n (uF′n of FIG. 8) that is previously encoded, decoded, and then reconstructed.

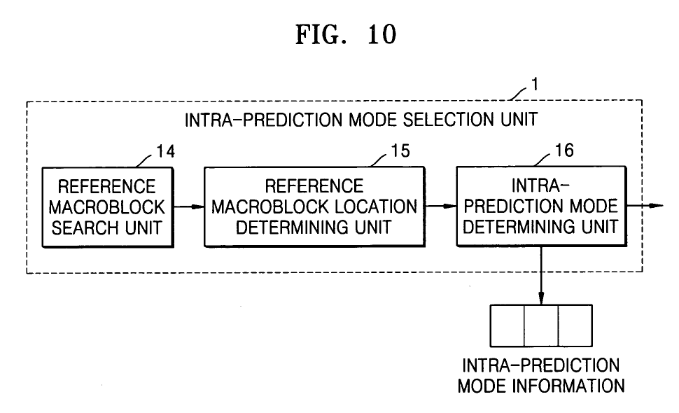

According to a first embodiment of the present invention, when a scanning order is predetermined in intra-prediction of each block, the intra-prediction encoder operates only with the intra-prediction unit 2 without the intra-prediction mode selection unit 1. In other words, the intra-prediction unit 2 performs prediction of blocks of each macroblock in the predetermined scanning order based on uF′n. In the first embodiment of the present invention, the intra-prediction unit 2 performs most of functions of an intra-prediction mode selection unit 1 of FIG. 10, but is different in that an intra-prediction mode is not selected but predetermined.

According to a second embodiment of the present invention, the intra-prediction mode selection unit 1 operates while being coupled to the intra-prediction unit 2. In other words, the intra-prediction mode selection unit 1 selects the most suitable prediction mode in a scanning order of blocks of the macroblock to be coded based on uF′n and the intra-prediction unit 2 performs intra-prediction according to the selected prediction mode.

The predicted macroblock P is subtracted from a current macroblock by the subtraction unit 5, and thus a difference macroblock Dn is created. The difference macroblock Dn is DCT transformed by the DCT transform unit 6 and is then quantized by the quantization unit 7, and thus quantized transform coefficients X are created. These coefficients X are ripple scanned by the ripple scan unit 8 and are then entropy encoded by the entropy encoding unit 9. The entropy encoded coefficients X create compressed bitstreams along with additional information required for decoding of a macroblock. The additional information includes intra-prediction mode information, quantization operation size information, and motion vector information. In particular, when the intra-prediction mode is selected according to the second embodiment of the present invention, the intra-prediction mode information shown in FIG. 8 contains information about the intra-prediction mode selected by the intra-prediction mode selection unit 1 and can be expressed with 2 bits to indicate 4 modes used in this embodiment of the present invention. These compressed bitstreams are transmitted to a network abstraction layer (NAL) for transmission or storage.

The reconstructed path is as follows.

The encoded macroblock coefficients X are decoded to reconstruct a frame used for encoding of another macroblock. In other words, the encoded macroblock coefficients X are inversely quantized by the inverse quantization unit 10 and are inverse DCT transformed by the inverse DCT transform unit 11. As a result, a difference macroblock D′n is created, which is not the same as the original difference macroblock Dn due to the influence of signal loss.

The predicted macroblock P is added to the difference macroblock D′n by the adder 12, and thus a reconstructed macroblock uF′n is created. The reconstructed macroblock uF′n is a distorted version of the original macroblock. To reduce the influence of such distortion, the filter 13 is added and a reconstructed reference frame is created from a macroblock F′n.

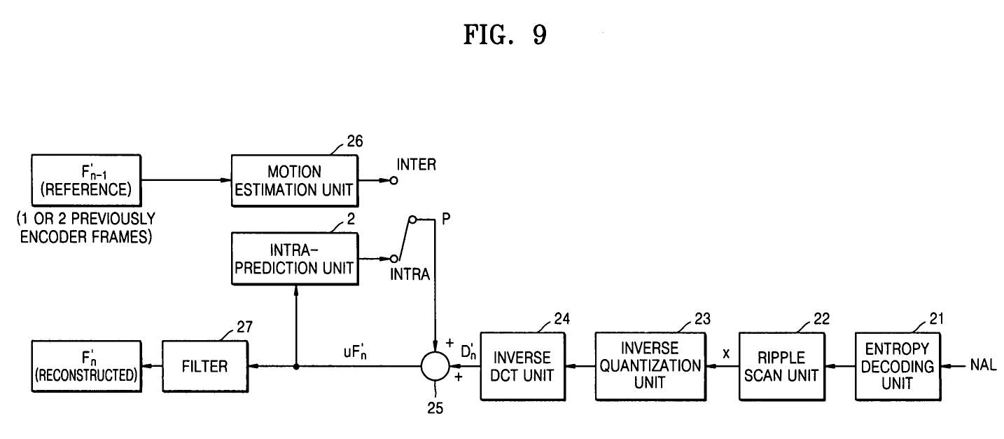

FIG. 9 is a schematic block diagram of an intra-prediction decoder according to an embodiment of the present invention.

Referring to FIG. 9, the intra-prediction decoder includes an entropy decoding unit 21, a ripple scan unit 22, an inverse quantization unit 23, an inverse DCT transform unit 24, an adder 25, a motion estimation unit 26, a filter 27, and an intra-prediction unit 2.

The intra-prediction decoder receives compressed bitstreams from the NAL. Data elements are entropy decoded by the entropy decoding unit 21. At this time, additional information required for decoding of a macroblock and, in particular, intra-prediction mode information according to the second embodiment of the present invention is extracted. This intra-prediction mode information is transmitted to the intra-prediction unit 2 and is used for selection of an intra-prediction mode. In the first embodiment of the present invention, since the scanning order for intra-prediction is predetermined, the intra-prediction mode information is not required. Data samples that are entropy decoded as described above are re-arranged by the ripple scan unit 22 to create a set of quantized coefficients X. The re-arranged data is inversely quantized by the inverse quantization unit 23 and is inverse DCT transformed by the inverse DCT transform unit 24, and thus D′n is created.

In the first embodiment of the present invention, the intra-prediction unit 2 performs intra-prediction in the predetermined scanning order and creates the predicted macroblock P. In the second embodiment of the present invention, the intra-prediction unit 2 performs intra-prediction according to the intra-prediction mode by referring to header information extracted by the entropy decoding unit 21, in particular, the intra-prediction mode information according to this embodiment of the present invention and then creates the predicted macroblock P.

In any of the first embodiment and the second embodiment of the present invention, the intra-prediction unit 2 performs prediction as shown in FIGS. 5A through 7H in the predetermined scanning order or the scanning order according to the intra-prediction mode information.

The predicted macroblock P is the same as the original predicted macroblock P that is created by the intra-prediction encoder. The predicted macroblock P is added to D′n by the adder 25, and thus uF′n is created. uF′n is filtered by the filter 27, and thus a decoded macroblock F′n is created.

FIG. 10 is a detailed block diagram of the intra-prediction mode selection unit 1 shown in FIG. 8.

Referring to FIG. 10, the intra-prediction mode selection unit 1 includes a reference macroblock search unit 14, a reference macroblock location determining unit 15, and an intra-prediction mode determining unit 16.

The reference macroblock search unit 14 searches for a reference macroblock that is adjacent to a macroblock to be coded and is within the present square ring including the macroblock to be coded and a reference macroblock that is adjacent to the macroblock to be coded and is within a previous square ring, with reference to the scanning direction of ROI-centered scanning.

The reference macroblock location determining unit 15 determines the location of a reference macroblock to be used for prediction of a macroblock to be coded. If only an initial origin macroblock exists, it is marked with A. If two macroblocks exists, each being included in the present square ring having the macroblock to be coded and in a previous square ring, the macroblock included in the present square ring is marked with A and the other is marked with D. If a macroblock is included in the present square ring and at least two macroblocks are included in a previous square ring, a macroblock that is included in the present square ring including the macroblock E and is coded immediately before the macroblock E is marked with A, a macroblock that is adjacent to the macroblock E and is included in a previous square ring that has been just coded is marked with B, and a macroblock that is adjacent to the macroblocks A and B and is included in a previous square ring that has been just coded is marked with D.

The intra-prediction mode determining unit 16 determines a mode having the minimum SAD using the determined reference macroblocks A, B, and D as a prediction mode. Here, a mode indicates a prediction order according to a scanning order. In other words, when the reference macroblock A exists or the reference macroblocks A and D exist, the intra-prediction mode determining unit 16 determines a mode having the smaller SAD as an intra-prediction mode by using two modes, i.e., mode 0 and mode 1 that only information about the macroblock A. If the reference macroblocks A, B, and D exist, the intra-prediction mode determining unit 16 calculates SADs between the macroblock E and predicted macroblocks according to two modes, i.e., mode 2 and mode 3 that use information of the macroblocks A, B, and D and determines a mode having the smaller SAD as an intra-prediction mode. In other words, after a predicted DC value of the macroblock E is calculated using both mode 0 and mode 1, an SAD between an actual DC value and the predicted DC value is obtained and a mode having the smaller SAD is selected.

In practice, when DC values of blocks of the macroblock E to be coded are E_{A}_{_{—}}DC, E_{B}_{_{—}}DC, E_{C}_{_{—}}DC, and E_{D}_{_{—}}DC and DC values of blocks of the predicted macroblock P are E′_{A}_{_{—}}DC, E′_{B}_{_{—}}DC, E′_{C}_{_{—}}DC, and E′_{D}_{_{—}}DC, an SAD is given by
SAD=|E_{A}_{_{—}}DC-E′_{A}_{_{—}}DC|+|E_{B}_{_{—}}DC-E′_{B}_{_{—}}DC|+|E_{C}_{_{—}}DC-E′_{C}_{_{—}}DC|+|E_{D}_{_{—}}DC-E′_{D}_{_{—}}DC|

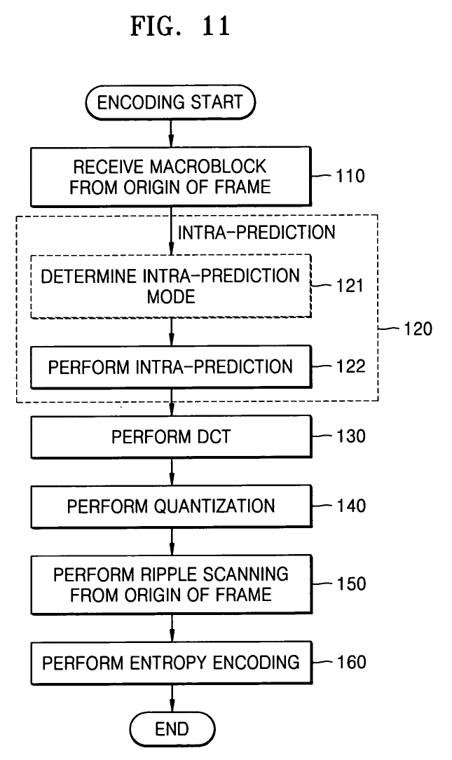

FIG. 11 is a flowchart illustrating an intra-prediction encoding method according to an embodiment of the present invention.

Referring to FIG. 11, a macroblock is received from the center of a frame in the scanning direction of ROI-centered scanning, in operation 110.

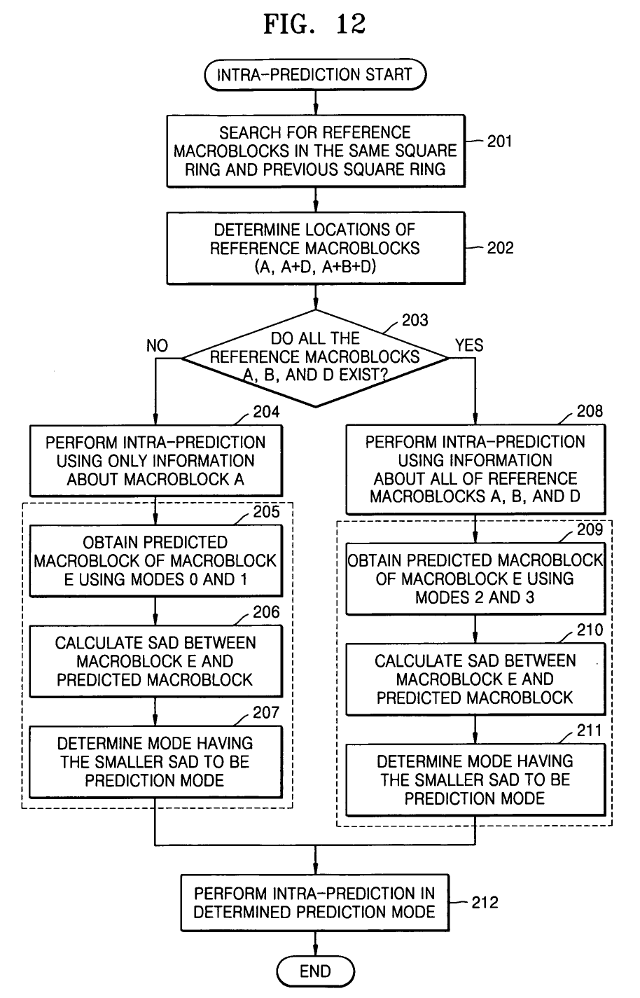

In operation 120, intra-prediction including operations 121 and 122 is performed. In operation 121, for intra-prediction, an intra-prediction mode is selected according to the first embodiment of the present invention. In operation 122, intra-prediction is performed according the selected intra-prediction mode or in a predetermined scanning order according to the second embodiment of the present invention. Intra-prediction will be described in detail with reference to FIG. 12.

In operation 130, the intrapredicted frame is DCT transformed.

In operation 140, the DCT transformed frame is quantized.

In operation 150, the quantized frame is ripple scanned from its center.

In operation 160, the ripple scanned data is entropy encoded. In entropy encoding, information about the intra-prediction mode selected in intra-prediction according to the second embodiment of the present invention is inserted into the ripple scanned data, is entropy encoded, and is then transmitted to the intra-prediction decoder side.

FIG. 12 is a detailed flowchart illustrating intra-prediction operation 120 shown in FIG. 11.

The first embodiment will be described with reference to FIG. 12.

First, a reference macroblock that is adjacent to a macroblock to be coded and is included in the present square ring including the macroblock to be coded is searched with reference to the scanning direction of ROI-centered scanning, in operation 201. Also, in operation 201, a reference macroblock that is adjacent to the macroblock to be coded and is included in a previous square ring is searched with reference to the scanning direction of ROI-centered scanning.

In operation 202, the location of the reference macroblock is determined.

In other words, when the initial origin macroblock only exists, it is marked with A.

Also, if two reference macroblocks exist, each being included in the present square ring and in the previous square ring, the reference macroblock included in the present square ring is marked with A and the reference macroblock included in the previous square ring is marked with D.

If a macroblock is included in the present square ring and at least two macroblocks are included in a previous square ring, a macroblock that is included in the present square ring including the macroblock E and is coded immediately before the macroblock E is marked with A, a macroblock that is adjacent to the macroblock E and is included in a previous square ring that has been just coded is marked with B, and a macroblock that is adjacent to the macroblocks A and B and is included in a previous square ring that has been just coded is marked with D.

In operation 203, once the reference macroblock is determined, it is checked whether all of the reference macroblocks A, B, and D exist. If any of the reference macroblocks A, B, and D does not exist, a process proceeds to operation 208.

If the reference macroblock A only exists or the reference macroblocks A and D only exist, information of the reference macroblock A is used for intra-prediction in operation 204. If all of the reference macroblocks A, B, and D exist, intra-prediction is performed using all of the information of the reference macroblocks A, B, and D.

In other words, intra-prediction is performed in a scanning order predetermined in a system, in operation 212. Such prediction is already described above with reference to FIG. 5A through 7H.

In the second embodiment of the present invention, since a prediction mode is not predetermined, each mode is performed and then a prediction mode is determined. A procedure that is only performed in the second embodiment of the present invention is marked with a dotted box in FIG. 12.

In operation 205, predicted macroblocks of the macroblock E are obtained using two modes, i.e., mode 0 and mode 1 that only use the information of the macroblock A. Here, mode 0 indicates a prediction order that two blocks adjacent to the macroblock A are first predicted and one of the remaining two blocks is then predicted. Mode 1 indicates a prediction order that two blocks adjacent to the macroblock A are first predicted and the other one of the remaining two blocks is predicted.

In operation 206, SADs between the macroblock E and the predicted macroblock are calculated. In other words, an SAD between the macroblock E and a predicted macroblock that is obtained in mode 0 and an SAD between the macroblock E and a predicted macroblock that is obtained in mode 1 are calculated.

In operation 207, a mode having the smaller SAD is determined to be a prediction mode.

In operation 212, intra-prediction is performed in the determined prediction mode. In practice, intra-prediction means taking the predicted macroblock that is already obtained in operation 205.

If all of the reference macroblocks A, B, and D exist, spatial intra-prediction is performed in the macroblock E using information of the reference macroblocks A, B, and D, in operation 208.

In other words, in operation 209, predicted macroblocks of the macroblock E are obtained using two modes, i.e., mode 2 and mode 3 that use information of all of the reference macroblocks A, B, and D. Here, mode 2 indicates a prediction order that a block that is simultaneously adjacent to the macroblocks A and B is first predicted, a block that is adjacent to the macroblock A is predicted, a block that is adjacent to the macroblock B is predicted, and the last block is predicted. Mode 3 indicates a prediction order that a block that is simultaneously adjacent to the macroblocks A and B is predicted, a block that is adjacent to the macroblock B is predicted, a block that is adjacent to the macroblock A is predicted, and the last block is predicted.

In operation 210, SADs between the macroblock E and the predicted macroblocks are calculated. In other words, an SAD between the macroblock E and a predicted macroblock that is obtained in mode 2 and an SAD between the macroblock E and a predicted macroblock that is obtained in mode 3 are calculated.

In operation 211, a mode having the smallest SAD between the two SADs is determined to be a prediction mode.

In operation 212, intra-prediction is performed in the determined prediction mode. In practice, intra-prediction means taking the predicted macroblock that is already obtained in operation 209.

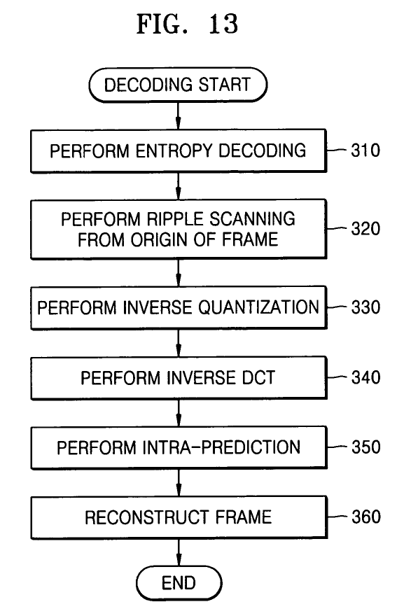

FIG. 13 is a flowchart illustrating intra-prediction decoding according to an embodiment of the present invention.

Referring to FIG. 13, entropy decoding begins in operation 310. In entropy decoding, header information of a frame is extracted, and information about an intra-prediction mode is also extracted.

In operation 320, ripple scanning is performed from the center of the frame that is created through entropy decoded.

In operation 330, the ripple scanned frame is inversely quantized.

In operation 340, the inversely quantized frame is inverse DCT transformed.

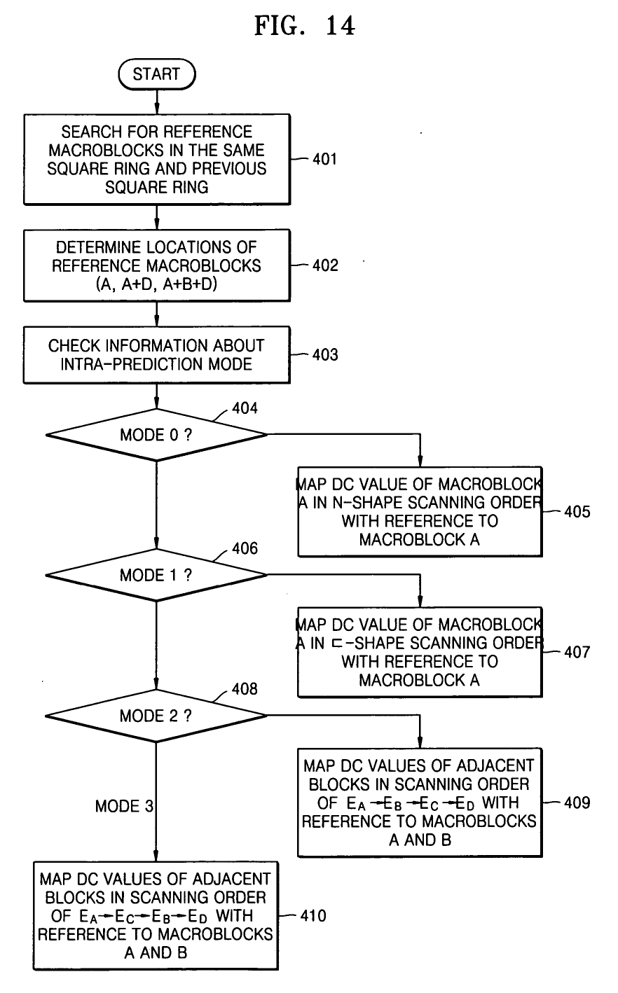

In operation 350, intra-prediction is performed on the inverse DCT transformed frame. At this time, in the first embodiment of the present invention, intra-prediction is performed in a predetermined scanning order. In the second embodiment of the present invention, intra-prediction is performed using the intra-prediction mode information obtained in operation 310. Intra-prediction will be described in detail with reference to FIG. 14.

Then, in operation 360, a frame is reconstructed from the intra-predicted frame.

FIG. 14 is a detailed flowchart illustrating intra-prediction shown in FIG. 13.

Referring to FIG. 14, in operation 401, a reference macroblock that is adjacent to a macroblock to be coded and is included in the present square ring as that of the macroblock to be coded is searched with reference to the scanning direction of ROI-centered scanning. Also, in operation 401, a reference macroblock that is adjacent to a macroblock to be coded and is included in a previous square ring is searched with reference to the scanning direction of ROI-centered scanning.

In operation 402, the location of a reference macroblock is determined.

In other words, if an initial origin macroblock only exists, it is marked with A. Also, if two macroblocks exist, each being included in the present square ring and in the previous square ring, the macroblock included in the present square ring is marked with A and the other is marked with D.

Also, if a macroblock is included in the present square ring and at least two macroblocks are included in a previous square ring, a macroblock that is included in the present square ring as that of the macroblock E and is coded immediately before the macroblock E is marked with A, a macroblock that is adjacent to the macroblock E and is included in a previous square ring that has been just coded is marked with B, and a macroblock that is adjacent to the macroblocks A and B and is included in a previous square ring that has been just coded is marked with D.

Once the reference macroblock is determined, intra-prediction mode information from the encoder side is checked in operation 403. In the first embodiment of the present invention, since the intra-prediction mode is predetermined in a system, such information of the intra-prediction mode can be referred to. In the second embodiment of the present invention, the intra-prediction mode information received from the encoder is received and can be referred to.

If an intra-prediction mode is mode 0 in operation 404, a DC value of the macroblock A is mapped to a DC value of the predicted macroblock with reference to the macroblock A in an N-shape scanning order in operation 405.

If an intra-prediction mode is mode 1 in operation 406, a DC value of the macroblock A is mapped to a DC value of the predicted macroblock with reference to the macroblock A in a [symbol] -shape scanning order in operation 407.

If an intra-prediction mode is mode 2 in operation 408, DC values of adjacent macroblocks are mapped to a DC value of the predicted macroblock with reference to the macroblocks A and B in a scanning order of E_{A}→E_{C}→E_{B}→E_{D} in operation 409.

If an intra-prediction mode is mode 3 in operation 410, DC values of adjacent macroblocks are mapped to a DC value of the predicted macroblock with reference to the macroblocks A and B in a scanning order of E_{A}→E_{B}→E_{C}→E_{D} in operation 411.

According to the above-described embodiments of the present invention, a video encoding/decoding method that is based on ROI-centered scanning instead of traditional raster scanning can be realized.

Meanwhile, the intra-prediction encoding/decoding method can also be embodied as a computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed over network coupled computer systems so that the computer readable code is stored and executed in a distributed fashion.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A prediction encoder comprising:
a prediction encoding unit which starts prediction from an origin macroblock of an area of interest of a video frame, continues prediction in a direction of ripple scanning with respect to a square ring that includes macroblocks and surrounds the origin macroblock, and encodes video by performing intra-prediction in 8×8 block units using information about a macroblock that has been just coded in a present square ring including a macroblock to be coded and at least one of macroblocks that are adjacent to the macroblock to be coded in a previous square ring which is inner square ring adjacent to the present square ring.

2. The prediction encoder of claim 1, wherein the prediction encoding unit predicts a discrete cosine transform (DCT) coefficient of each block of the macroblock to be coded using a DCT coefficient of each block of the origin macroblock or a DCT coefficient of each block of the macroblock A, when the macroblock to be coded is a first macroblock after completion of encoding of the origin macroblock or there exist two reference macroblocks of the macroblock to be coded,
wherein the two reference macroblocks includes a macroblock A that is included in the present square ring and has been just coded and a macroblock D that is included in the present square ring and is adjacent to the macroblock to be coded.

3. The prediction encoder of claim 2, wherein the prediction encoding unit predicts the remaining blocks after the prediction encoding unit first predicts, among the blocks of the macroblock to be coded, a block that is adjacent to the origin macroblock or the macroblock A.

4. The prediction encoder of claim 1, wherein the prediction encoding unit predicts a DCT coefficient of each block of the macroblock to be coded using DCT coefficients of blocks of the macroblocks A, B, and D, when a macroblock A that is included in the present square ring and has been just coded, a macroblock B that is included in the previous square ring and is adjacent to the macroblock to be coded, and a macroblock D that is included in the previous square ring and is adjacent to the macroblocks A and B exist as reference macroblocks of the macroblock to be coded.

5. The prediction encoder of claim 4, wherein the prediction encoding unit first predicts, among the blocks of the macroblock to be coded, a block E_{A} that is adjacent to the macroblocks A and B, a block E_{B} that is only adjacent to the macroblock A or a block E_{C} that is only adjacent to the macroblock B, and then a block E_{D} that is adjacent to the blocks E_{B} and E_{C}.

6. The prediction encoder of claim 2, wherein the prediction encoding unit includes:
a reference macroblock search unit searching for a reference macroblock included in the present square ring and a reference macroblock that is included in the previous square ring and is adjacent to the macroblock to be coded;
a reference macroblock location determining unit: determining the origin macroblock to be A when only the origin macroblock exists; determining a macroblock included in the present square ring to be A and a macroblock included in the previous square ring to be D when two macroblocks exist, each being included in the present square ring and in the previous square ring; and determining a macroblock that is included in the present square ring and has been just coded to be A, a macroblock that is adjacent to the macroblock to be coded in the previous square ring to be B, and a macroblock that is adjacent to the macroblocks A and B and is included in the previous square ring to be D, when a macroblock is included in the present square ring and at least two macroblocks are included in the previous square ring; and
an intra-prediction unit encoding the macroblock in a predetermined scanning order of the blocks of the macroblock to be coded using the determined reference macroblocks A, B, and D.

7. The prediction encoder of claim 6, wherein the prediction encoding unit further comprises an intra-prediction mode determining unit determining a prediction mode having the minimum sum of absolute differences between the macroblock to be coded and each predicted macroblock in an intra-prediction mode according to a scanning order using the reference macroblocks A, B, and D that are determined to determine the scanning order.

8. The prediction encoder of claim 6, wherein the prediction encoding unit includes:
a discrete cosine transform unit performing DCT on a difference between the intra-predicted macroblock and the macroblock to be coded;
a quantization unit quantizing transformed DCT coefficients;
a ripple scan unit starting scanning from the origin macroblock of a frame composed of the quantized DCT coefficients and continuing to scan macroblocks of a next square ring in a ripple scanning direction; and
an entropy encoding unit entropy encoding ripple scanned data samples.

9. A prediction decoder comprising:
a prediction decoding unit which starts prediction from a origin macroblock of an area of interest of a video frame, continues prediction in a direction of ripple scanning with respect to a square ring that includes macroblocks and surrounds the origin macroblock, and decoding video by performing intra-prediction in 8×8 block units using information about a macroblock that has been just decoded in a present square ring including a macroblock to be decoded and at least one of macroblocks that are adjacent to the macroblock to be decoded in a previous square ring which is inner square ring adjacent to the present square ring.

10. The prediction decoder of claim 9, wherein the prediction encoding unit predicts a discrete cosine transform (DCT) coefficient of each block of the macroblock to be decoded using a DCT coefficient of each block of the origin macroblock or a DC coefficient of each block of the macroblock A, when the macroblock to be decoded is a first macroblock after completion of decoding of the origin macroblock or there exist two reference macroblocks of the macroblock to be decoded,
wherein the two reference macroblocks include a macroblock A that is included in the present square ring having the macroblock to be decoded and has been just decoded and a macroblock D that is included in the previous square ring and is adjacent to the macroblock to be decoded.

11. The prediction decoder of claim 10, wherein the prediction encoding unit predicts the remaining blocks after the prediction decoding unit first predicts, among the blocks of the macroblock to be decoded, a block that is adjacent to the origin macroblock or the macroblock A.

12. The prediction decoder of claim 9, wherein the prediction encoding unit predicts a DCT coefficient of each block of the macroblock to be decoded using DCT coefficients of blocks of the macroblocks A, B, and D when a macroblock A that is included in the present square ring and has been just decoded, a macroblock B that is included in the previous square ring and is adjacent to the macroblock to be decoded, and a macroblock D that is included in the previous square ring and is adjacent to the macroblocks A and B exist as reference macroblocks of the macroblock to be decoded.

13. The prediction decoder of claim 12, wherein the prediction decoding unit first predicts, among the blocks of the macroblock to be decoded, a block E_{A} that is adjacent to the macroblocks A and B, a block E_{B} that is only adjacent to the macroblock A or a block E_{C} that is only adjacent to the macroblock B, and then a block E_{D} that is adjacent to the blocks E_{B} and E_{C}.

14. The prediction decoder of claim 9, wherein the prediction decoding unit includes:
a reference macroblock search unit searching for a reference macroblock included in the present square ring and a reference macroblock that is included in the previous square ring and is adjacent to the macroblock to be decoded;
a reference macroblock location determining unit: determining the origin macroblock to be A when only the origin macroblock exists; determining a macroblock included in the present square ring to be A and a macroblock included in the previous square ring to be D when two macroblocks exist, each being included in the present square ring and in the previous square ring; and determining a macroblock that is included in the present square ring and has been just decoded to be A, a macroblock that is adjacent to the macroblock to be decoded in the previous square ring to be B, and a macroblock that is adjacent to the macroblocks A and B and is included in the previous square ring to be D, when a macroblock is included in the present square ring and at least two macroblocks are included in the previous square ring; and
an intra-prediction unit decoding the macroblock in a predetermined scanning order of the blocks of the macroblock to be decoded using the determined reference macroblocks A, B, and D.

15. The prediction decoder of claim 14, wherein the prediction decoding unit further includes an intra-prediction mode determining unit determining a prediction mode having the minimum sum of absolute differences between the macroblock to be decoded and each predicted macroblock in an intra-prediction mode according to a scanning order using the reference macroblocks A, B, and D that are determined to determine the scanning order.

16. The prediction decoder of claim 15, further comprising:
an entropy decoding unit entropy decoding a bitstream received from a prediction encoder;
a ripple scan unit starting scanning from the origin macroblock of a frame composed of entropy-decoded data samples and continuing to scan macroblocks of a next square ring in a ripple scanning direction;
an inverse quantization unit inversely quantizing the ripple-scanned data samples;
an inverse discrete cosine transform (IDCT) unit performing IDCT on the inversely quantized data samples; and
an adder adding a macroblock composed of inversely-quantized and IDCTed coefficients to the predicted macroblock.

17. A prediction encoding method comprising:
prediction encoding by starting prediction from a origin macroblock of an area of interest of a video frame, continuing prediction in a direction of ripple scanning with respect to a square ring that includes macroblocks and surrounds the origin macroblock, and encoding video by performing intra-prediction in 8×8 block units using information about a macroblock that has been just coded in a present square ring including a macroblock to be coded and at least one of macroblocks that are adjacent to the macroblock to be coded in a previous square ring which is inner square ring adjacent to the present square ring.

18. The prediction encoding method of claim 17, wherein the prediction encoding includes predicting a discrete cosine transform (DCT) coefficient of each block of the macroblock to be coded using a DCT coefficient of each block of the origin macroblock or a DC coefficient of each block of the macroblock A when the macroblock to be coded is a first macroblock after completion of encoding of the origin macroblock or there exist two reference macroblocks of the macroblock to be coded,
wherein the two reference macroblocks include a macroblock A that is included in the present square ring and has been just coded and a macroblock D that is included in the previous square ring and is adjacent to the macroblock to be coded.

19. The prediction encoding method of claim 18, wherein after first predicting, among the blocks of the macroblock to be coded, a block that is adjacent to the origin macroblock or the macroblock A, the remaining blocks are predicted.

20. The prediction encoding method of claim 17, wherein the prediction encoding includes predicting a DCT coefficient of each block of the macroblock to be coded is predicted using DCT coefficients of blocks of the macroblocks A, B, and D when a macroblock A that is included in the present square ring and has been just coded, a macroblock B that is included in the previous square ring and is adjacent to the macroblock to be coded, and a macroblock D that is included in the previous square ring and is adjacent to the macroblocks A and B exist as reference macroblocks of the macroblock to be coded.

21. The prediction encoding method of claim 20, wherein, in the prediction encoding, among the blocks of the macroblock to be coded, a block E_{A} that is adjacent to the macroblocks A and B is first predicted, a block E_{B} that is only adjacent to the macroblock A or a block E_{C} that is only adjacent to the macroblock B is predicted, and then a block E_{D} that is adjacent to the blocks E_{B} and E_{C} is predicted.

22. The prediction encoding method of claim 17, wherein the prediction encoding includes:
searching for a reference macroblock included in the present square ring and a reference macroblock that is included in the previous square ring and is adjacent to the macroblock to be coded;
determining the origin macroblock to be A when only the origin macroblock exists, determining a macroblock included in the present square ring to be A and a macroblock included in the present square ring to be D when two macroblocks exist, each being included in the present square ring and in the previous square ring, and determining a macroblock that is included in the present square ring and has been just coded to be A, a macroblock that is adjacent to the macroblock to be coded in the previous square ring to be B, and a macroblock that is adjacent to the macroblocks A and B and is included in the previous square ring to be D, when a macroblock is included in the present square ring and at least two macroblocks are included in the previous square ring; and
encoding the macroblock in a predetermined scanning order of the blocks of the macroblock to be coded using the determined reference macroblocks A, B, and D.

23. The prediction encoding method of claim 22, wherein the prediction encoding further comprises determining a prediction mode having the minimum sum of absolute differences between the macroblock to be coded and each predicted macroblock in an intra-prediction mode according to a scanning order using the reference macroblocks A, B, and D that are determined to determine the scanning order.

24. The prediction encoding method of claim 22, wherein the prediction encoding includes:
performing DCT on a difference between the intra-predicted macroblock and the macroblock to be coded;
quantizing transformed DCT coefficients;
starting scanning from the origin macroblock of a frame composed of the quantized DCT coefficients and continuing to scan macroblocks of a next square ring in a ripple scanning direction; and
entropy encoding ripple scanned data samples.

25. A prediction decoding method comprising:
prediction decoding by starting prediction from a origin macroblock of an area of interest of a video frame, continuing prediction in a direction of ripple scanning with respect to a square ring that includes macroblocks and surrounds the origin macroblock, and decoding video by performing intra-prediction in 8×8 block units using information about a macroblock that has been just decoded in a present square ring including a macroblock to be decoded and at least one of macroblocks that are adjacent to the macroblock to be decoded in a previous square ring which is inner square ring adjacent to the present square ring.

26. The prediction decoding method of claim 25, wherein the prediction decoding includes predicting a discrete cosine transform (DCT) coefficient of each block of the macroblock to be decoded using a DCT coefficient of each block of the origin macroblock or a DC coefficient of each block of the macroblock A, when the macroblock to be decoded is a first macroblock after completion of decoding of the origin macroblock or there exist two reference macroblocks of the macroblock to be decoded,
wherein the two reference macroblocks include a macroblock A that is included in the present square ring and has been just decoded and a macroblock D that is included in the previous square ring and is adjacent to the macroblock to be decoded.

27. The prediction decoding method of claim 26, wherein, after first predicting, among the blocks of the macroblock to be decoded, a block that is adjacent to the origin macroblock or the macroblock A, the remaining blocks are predicted.

28. The prediction decoding method of claim 25, wherein the prediction encoding includes predicting a DCT coefficient of each block of the macroblock to be decoded using DCT coefficients of blocks of the macroblocks A, B, and D when a macroblock A that is included in the present square ring and has been just decoded, a macroblock B that is included in the previous square ring and is adjacent to the macroblock to be decoded, and a macroblock D that is included in the previous square ring and is adjacent to the macroblocks A and B exist as reference macroblocks of the macroblock to be decoded.

29. The prediction decoding method of claim 28, wherein, in the prediction decoding, among the blocks of the macroblock to be decoded, a block E_{A} that is adjacent to the macroblocks A and B is first predicated, a block E_{B} that is only adjacent to the macroblock A or a block E_{C} that is only adjacent to the macroblock B is predicted, and then a block E_{D} that is adjacent to the blocks E_{B} and E_{C} is predicted.

30. The prediction decoding method of claim 25, wherein the prediction decoding includes:
searching for a reference macroblock included in the present square ring and a reference macroblock that is included in the previous square ring and is adjacent to the macroblock to be decoded;
determining the origin macroblock to be A when only the origin macroblock exists, determining a macroblock included in the present square ring to be A and a macroblock included in the previous square to be D when two macroblocks exist, each being included in the present square ring and in the previous square ring, and determining a macroblock that is included in the present square ring to be A, a macroblock that is adjacent to the macroblock to be decoded in the previous square ring to be B, and a macroblock that is adjacent to the macroblocks A and B and is included in the previous square ring to be D, when a macroblock is included in the present square ring and at least two macroblocks are included in the previous square ring; and
decoding the macroblock in a predetermined scanning order of the blocks of the macroblock to be decoded using the determined reference macroblocks A, B, and D.

31. The prediction decoding method of claim 30, wherein the prediction decoding includes determining a prediction mode having the minimum sum of absolute differences between the macroblock to be decoded and each predicted macroblock in an intra-prediction mode according to a scanning order using the reference macroblocks A, B, and D that are determined to determine the scanning order.

32. The prediction decoding method of claim 30, further comprising:
entropy decoding a bitstream received from a prediction encoder;
starting scanning from the origin macroblock of a frame composed of entropy-decoded data samples and continuing to scan macroblocks of a next square ring in a ripple scanning direction;
inversely quantizing the ripple-scanned data samples;
inversely discrete cosine transformation on the inversely quantized data samples; and
adding a macroblock composed of inversely quantized and IDCTed coefficients to the predicted macroblock.
